(19) United States
(12) Patent Application Publication
(10) Pub. No.: US 2023/0273652 A1
(43) Pub. Date: Aug. 31, 2023

(54) ELECTRONIC DEVICE AND METHOD FOR OUTPUTTING AUDIO SIGNAL

(71) Applicant: SAMSUNG ELECTRONICS CO., LTD., Suwon-si (KR)

(72) Inventors: Injune CHOI, Suwon-si (KR); Kyumin KIM, Suwon-si (KR); Hyojin LEE, Suwon-si (KR)

(21) Appl. No.: 18/310,777

(22) Filed: May 2, 2023

Related U.S. Application Data
(63) Continuation of application No. PCT/KR2021/003218, filed on Mar. 16, 2021.

(30) Foreign Application Priority Data
Dec. 3, 2020 (KR) 10-2020-0167673
Jan. 20, 2021 (KR) 10-2021-0008121

(51) Int. Cl. G06F 1/16; G06F 3/16; H04R 3/12

(52) U.S. Cl. CPC G06F 1/1688; G06F 1/1652; G06F 1/1677; G06F 3/165; H04R 3/12; H04R 2499/11

(57) ABSTRACT

An example electronic device may include a display module which is bent or unfolded, and includes a display for providing a content; a plurality of audio output modules for outputting an audio signal; an audio module for converting the audio signal to an analog signal or converting an analog signal to the audio signal; and a processor electrically connected to the display module, the plurality of audio output modules, and the audio module. The processor is configured to set the plurality of audio output modules to an output-available state, determine an audio output module to output the audio signal from among the plurality of audio output modules, on the basis of a flex state of the display, and transmit the audio signal, which is converted to an analog signal by the audio module, to the plurality of audio output modules, and the audio output module, which is determined to output the audio signal, from among the plurality of audio output modules outputs the audio signal converted to the analog signal.

### CROSS-REFERENCE TO RELATED APPLICATIONS

This application is a continuation of International Application No. PCT/KR2021/003218, designating the United States, filed Mar. 16, 2021, in the Korean Intellectual Property Receiving Office and claiming priority to Korean Patent Application No. 10-2020-0167673, filed Dec. 3, 2020, in the Korean Intellectual Property Office and to Korean Patent Application No. 10-2021-0008121 filed Jan. 20, 2021 in the Korean Intellectual Property Office. The entire disclosures of each of these applications are incorporated herein by reference for all purposes.

### BACKGROUND

### Field

The disclosure relates to an electronic device and method for outputting an audio signal.

### Description of Related Art

To output an audio signal from an electronic device, routing may be set from an application that requests to output an audio signal to an audio output module that outputs the audio signal.

When a type of audio output module that outputs the audio signal is changed, the set routing may need to be reset. The audio signal is not transmitted to the changed audio output module until the routing is reset, and thus the audio signal may temporarily stop being output.

For example, when a song is played through a speaker of a smartphone and then played through wireless earphones, routing from a corresponding music application to the speaker may need to be changed to routing from the music application to the wireless earphones. While the routing is being reset from the music application to the wireless earphones, the song being played may be temporarily stopped.

With the recent introduction of flexible displays that are bent or unfolded and provide content, such as, for example, rollable smartphones or foldable smartphones, there may also be cases of interference between audio output modules depending on a flex state of such a display. In addition, when an audio output module being used is changed according to the flex state of the display, outputting an audio signal may be suspended temporarily. Therefore, there is a desire for a technology that solves the foregoing.

### SUMMARY

According to various example embodiments, an electronic device and method for outputting an audio signal are provided that may prevent occurrence of interference between audio output modules of the electronic device as a flex state of a display is changed.

According to various example embodiments, an electronic device and method for outputting an audio signal are provided that may seamlessly output an audio signal even when an audio output module being used is changed as a flex state of a display is changed.

According to an embodiment, an electronic device may include a display module including a display configured to be bent or unfolded and provide content; a plurality of audio output modules configured to output an audio signal; an audio module configured to convert the audio signal to an analog signal or convert an analog signal to the audio signal; and a processor electrically connected to the display module, the plurality of audio output modules, and the audio module, wherein the processor may be configured to set the plurality of audio output modules to be in an output-available state; determine an audio output module for outputting the audio signal from among the plurality of audio output modules based on a flex state of the display; and transmit the audio signal converted to an analog signal by the audio module to the plurality of audio output modules, wherein an audio output module determined as the audio output module for outputting the audio signal from among the plurality of audio output modules may output the audio signal converted to the analog signal.

According to an embodiment, an electronic device may include a display module including a display configured to be bent or unfolded and provide content; a plurality of audio output modules configured to output an audio signal; an auxiliary processor configured to process the audio signal; and a main processor electrically connected to the display module, the plurality of audio output modules, and the auxiliary processor, wherein the main processor may be configured to set routing for the audio signal through the auxiliary processor to transmit the audio signal to the plurality of audio output modules; determine a channel of the audio signal based on a flex state of the display; and set whether to activate each of the plurality of audio output modules according to the determined channel, and the auxiliary processor may be configured to receive the audio signal from the main processor and transmit the audio signal to the plurality of audio output modules based on the determined channel, wherein an audio output module activated by the main processor among the plurality of audio output modules may output the audio signal received from the auxiliary processor.

According to an embodiment, an audio signal outputting method performed by an electronic device may include setting a plurality of audio output modules of the electronic device to be in an output-available state; determining an audio output module for outputting an audio signal from among the plurality of audio output modules based on a flex state of a display of the electronic device; transmitting the audio signal to the plurality of audio output modules; and outputting the audio signal to an audio output module determined as the audio output module for outputting the audio signal among the plurality of audio output modules.

According to various example embodiments, an audio signal may be output such that there is no interference between audio output modules of an electronic device occurring as a flex state of a display is changed.

According to various example embodiments, an audio signal may be seamlessly output even when an audio output module being used is changed as a flex state of a display is changed.

According to various example embodiments, an audio signal may be seamlessly output even when the number of audio output modules to be used is changed as a foldable display of an electronic device is folded or unfolded.

According to various example embodiments, an audio signal may be seamlessly output even when the number of audio output modules to be used is changed as a rollable display of an electronic device is rolled or unfolded.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a block diagram illustrating an example electronic device in a network environment according to various embodiments;

FIG. 2A is a perspective view of an example electronic device in a flex state of a display when the display of the electronic device is a foldable display according to various embodiments;

FIG. 2B is a plane view of an example electronic device in a flex state of a display when the display of the electronic device is a foldable display according to various embodiments;

FIG. 2C is a perspective view of an example electronic device in a flex state of a display when the display of the electronic device is a rollable display according to various embodiments;

FIG. 2D is a perspective view of an example electronic device configured to output an audio signal based on a flex state of a display when the display of the electronic device is a rollable display according to various embodiments;

FIG. 3 is a diagram illustrating an example audio output module used based on a flex state of a display of an electronic device according to various embodiments;

FIG. 4 is a diagram illustrating an example of an occurrence of a mute interval in a process of outputting an audio signal as a flex state of a display of an example electronic device is changed according to various embodiments;

FIG. 5 is a block diagram illustrating an example audio module according to various embodiments;

FIGS. 6A, 6B, and 6C are diagrams illustrating a system layer of an example electronic device for outputting an audio signal according to various embodiments;

FIG. 7 is a diagram illustrating a process of processing an audio signal in an example audio module according to various embodiments; and

FIG. 8 is a flowchart illustrating an example method of outputting an audio signal according to various embodiments.

### DETAILED DESCRIPTION

Hereinafter, embodiments will be described in detail with reference to the accompanying drawings. When describing the embodiments with reference to the accompanying drawings, like reference numerals refer to like elements and a description related thereto will not be repeated.

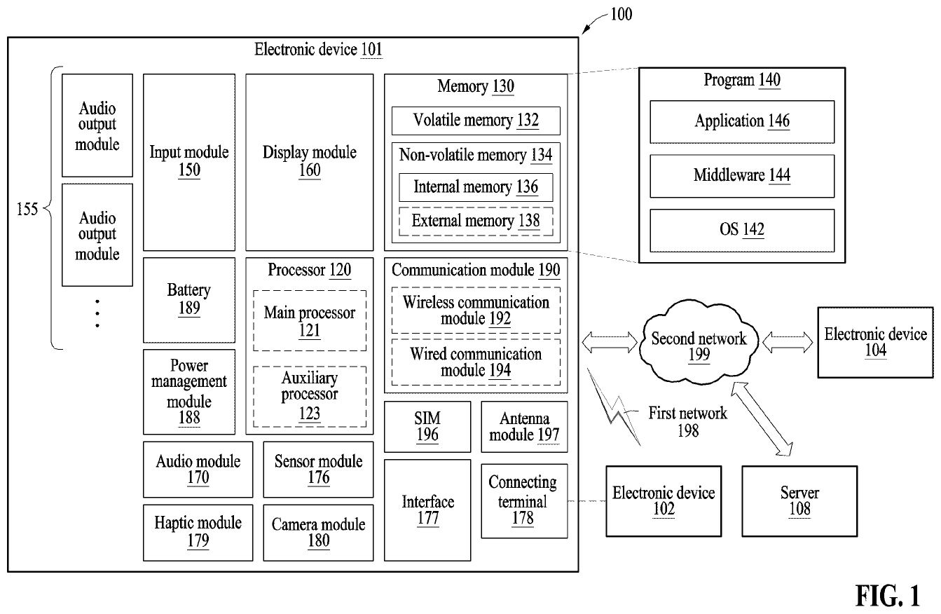

FIG. 1 is a block diagram illustrating an example electronic device in a network environment according to various embodiments.

Referring to FIG. 1, an electronic device 101 in a network environment 100 may communicate with an electronic device 102 via a first network 198 (e.g., a short-range wireless communication network), or communicate with at least one of an electronic device 104 and a server 108 via a second network 199 (e.g., a long-range wireless communication network). The electronic device 101 may communicate with the electronic device 104 via the server 108. The electronic device 101 may include a processor 120, a memory 130, an input module 150, at least one audio output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added to the electronic device 101. In various embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or data stored in the volatile memory 132, and store resulting data in a non-volatile memory 134. The processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). The auxiliary processor 123 (e.g., an ISP or a CP) may be implemented as a portion of another component (e.g., the camera module 180 or the communication module 190) that is functionally related to the auxiliary processor 123. The auxiliary processor 123 (e.g., an NPU) may include a hardware structure specifically for artificial intelligence (AI) model processing. An AI model may be generated by machine learning. The learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The audio output module 155 may output a sound signal to the outside of the electronic device 101. The audio output module 155 may include, for example, a speaker or a receiver. The speaker may be used for general purposes, such as playing multimedia or playing a recording. The receiver may be used to receive an incoming call. The receiver may be implemented separately from the speaker or as a part of the speaker.

The display module 160 may visually provide information to the outside (e.g., a user) of the electronic device 101. The display module 160 may include, for example, a display, a hologram device, or a projector, and control circuitry to control its corresponding one of the display, the hologram device, and the projector. The display module 160 may include a touch sensor adapted to sense a touch, or a pressure sensor adapted to measure an intensity of a force of the touch.

The audio module 170 may convert sound into an electric signal or vice versa. The audio module 170 may obtain the sound via the input module 150 or output the sound via the audio output module 155 or an external electronic device (e.g., the electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with an external electronic device (e.g., the electronic device 102) directly (e.g., by wire) or wirelessly. The interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). The connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. The haptic module 179 may include, for example, a motor, a piezoelectric element, or an electric stimulator.

The camera module 180 may capture a still image and moving images. The camera module 180 may include one or more lenses, image sensors, ISPs, and flashes.

The power management module 188 may manage power supplied to the electronic device 101. The power management module 188 may be implemented as, for example, at least a part of a power management integrated circuit (PMIC).

The battery 189 may supply power to at least one component of the electronic device 101. The battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., an LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4^{th} generation (4G) network, and a next-generation communication technology, e.g., new radio (NR) access technology.

The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). The wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

The antenna module 197 may form an mmWave antenna module. The mmWave antenna module may include a PCB, an RFIC on a first surface (e.g., a bottom surface) of the PCB or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the above-described components may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. All or some of operations to be executed by the electronic device 101 may be executed by one or more of the external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or service, may request one or more external electronic devices to perform at least a part of the function or service. The one or more external electronic devices receiving the request may perform the at least part of the function or the service requested, or an additional function or an additional service related to the request and may transfer a result of the performance to the electronic device 101. The electronic device 101 may provide the result, with or without further processing of the result, as at least part of a response to the request. To that end, cloud computing, distributed computing, mobile edge computing (MEC), or client-server computing technology may be used, for example. The electronic device 101 may provide ultra-low latency services using, e.g., distributed computing or MEC. According to an embodiment, the external electronic device (e.g., the electronic device 104) may include an Internet-of-things (IoT) device. The server 108 may be an intelligent server using machine learning and/or a neural network. The external electronic device (e.g., the electronic device 104) or the server 108 may be included in the second network 199. The electronic device 101 may be applied to intelligent services (e.g., a smart home, a smart city, a smart car, or healthcare) based on 5G communication technology or IoT-related technology.

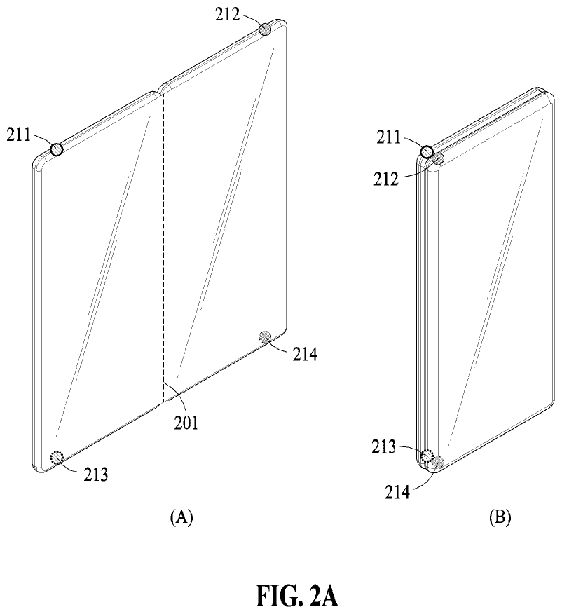

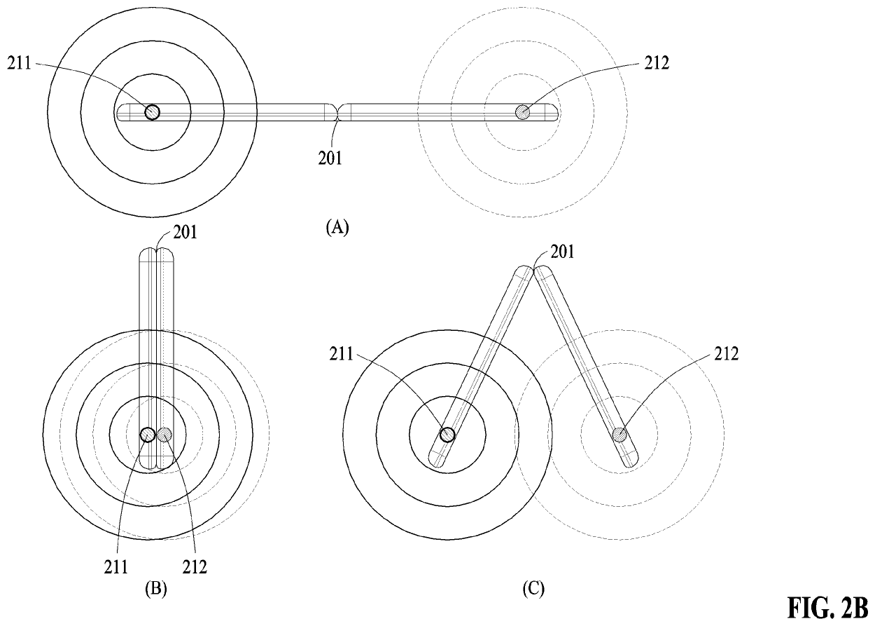

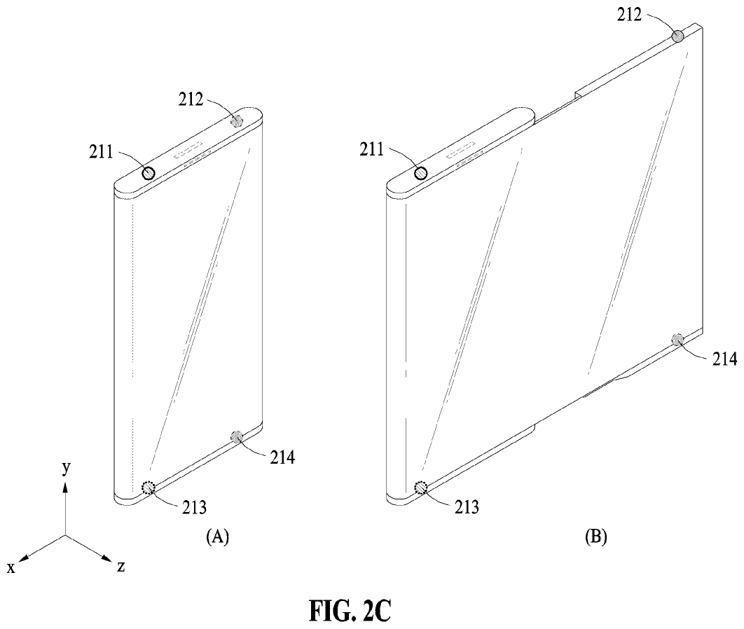

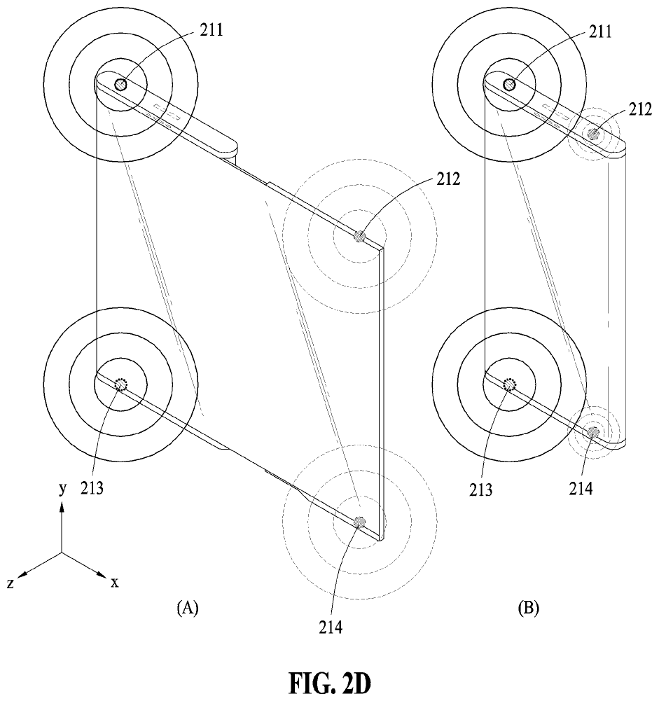

According to various embodiments, the electronic device 101 may employ a bendable flexible display as shown in FIGS. 2A, 2B, 2C, and 2D. For example, the electronic device 101 may employ various types of flexible displays including, for example, a foldable display that is folded or unfolded by a specific angle or curvature, a bendable display that is bent or unfolded by a specific curvature, and a rollable display of which one end is rolled or unfolded.

According to various embodiments, a flex state of a display described herein refers, foe example, to a bent or unfolded state of the display of the electronic device 101. For example, when the flex state is a first state, it may refer, for example, to a state in which the display of the electronic device 101 is unfolded as shown in (A) of FIG. 2A and (B) of FIG. 2C. For example, when the flex state is a second state, it may refer, for example, to a state in which a portion of the display of the electronic device 101 is bent as shown in (B) of FIG. 2A, (C) of FIG. 2B, and (A) of FIG. 2C.

According to various embodiments, the flex state of the display may vary according to a type of display included in the electronic device 101. For example, when the display of the electronic device 101 is a foldable display as shown in FIG. 2A, the first state may refer, for example, to a state in which the display is unfolded as shown in (A) of FIG. 2A and (A) of FIG. 2B, and the second state may refer, for example, to a state in which portions of the display divided into two with respect to a folding axis are folded in parallel as shown in (B) of FIG. 2A and (B) of FIG. 2B.

According to an embodiment, when the display of the electronic device 101 is a foldable display as shown in FIG. 2A, a third state may refer, for example, to a state in which portions of the display divided into two with respect to the folding axis are folded not to be in parallel as shown in (C) of FIG. 2B.

According to an embodiment, when the display of the electronic device 101 is a foldable display including two or more folding axes, a fourth state may refer, for example, to a state in which the display is folded with respect to each folding axis. According to various embodiments, the flex state of the display is not limited to the foregoing examples and may be additionally defined according to a change of the display.

According to an embodiment, when the display of the electronic device 101 is a rollable display as shown in FIG. 2C, the first state may refer, for example, to a state in which the display is unfolded as shown in (B) of FIG. 2C and (A) of FIG. 2D, and the second state may refer, for example, to a state in which one end of the display is rolled or one corner of the display is rolled as shown in (A) of FIG. 2C and (B) of FIG. 2D.

According to an embodiment, when the display of the electronic device 101 is a rollable display, the third state may refer, for example, to a state in which two parallel corners of the display are rolled. According to various embodiments, the flex state of the display is not limited to the foregoing examples and may be additionally defined according to a change of the display.

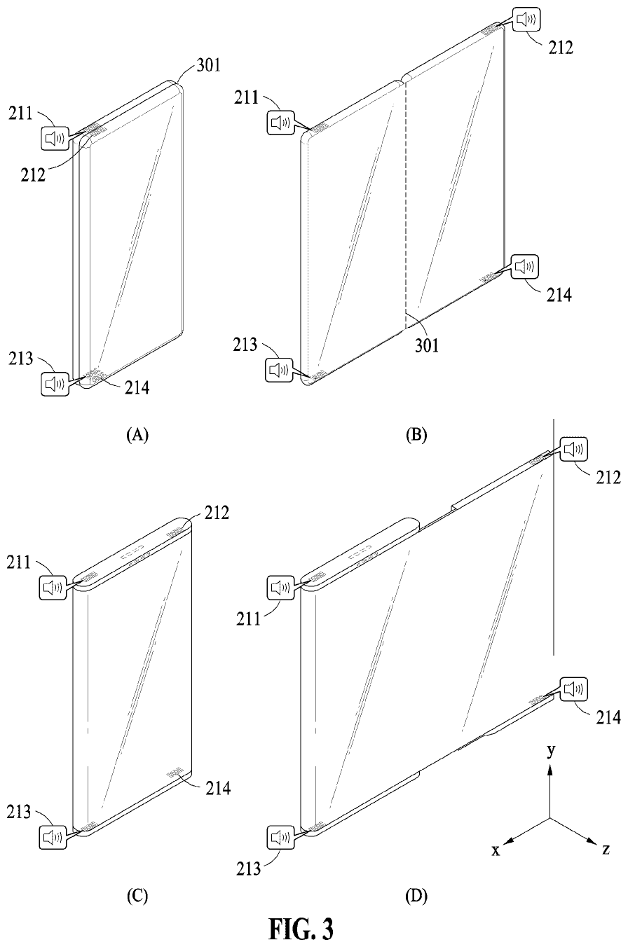

The electronic device 101 will be described under the assumption that it is a foldable electronic device 101 having a foldable display with reference to FIGS. 2A, 2B, and (A) and (B) of FIG. 3, but examples are not limited thereto.

The electronic device 101 will be described under the assumption that it is a rollable electronic device 101 having a rollable display with reference to FIGS. 2C, 2D, and (C) and (D) of FIG. 3, but examples are not limited thereto.

FIG. 2A is a perspective view of the electronic device 101 in the flex state of the display when the display of the electronic device 101 is a foldable display according to various embodiments.

The foldable display may refer, for example, to a display that is to be folded or unfolded with respect to a folding axis 201 (or a folding line). According to an embodiment, the electronic device 101 may be divided into two parts by the folding axis 201.

According to an embodiment, in the electronic device 101, the respective sizes or areas of the two parts of the electronic device 101 divided by the folding axis 201 may be the same as shown in FIG. 2A. According to an embodiment, in the electronic device 101, the sizes or areas of the two parts of the electronic device 101 divided by the folding axis 201 may be different from each other unlike what is shown in FIG. 2A.

According to an embodiment, the respective sizes of two screens of the foldable display divided by the folding axis 201 may be different from each other according to a position of the folding axis 201. The folding axis 201 is not limited to the example shown in FIG. 2A.

According to an embodiment, the electronic device 101 of FIG. 2A may include first through fourth audio output modules (e.g., (a), (b), (c), and (d) of FIG. 2A, e.g., the audio output module 155 of FIG. 1). The audio output modules of FIG. 2A (e.g., (a), (b), (c), and (d) of FIG. 2A) are provided only as an example, and the number of audio output modules included in the electronic device 101 is not limited thereto.

The first audio output module (e.g., 211 of FIG. 2A) may be disposed at a corner in an x-axis positive direction and a y-axis positive direction of an orthogonal coordinate system based on a center of the display. The second audio output module (e.g., 212 of FIG. 2A) may be disposed at a corner in an x-axis negative direction and the y-axis positive direction of the orthogonal coordinate system based on the center of the display. The third audio output module (e.g., 213 of FIG. 2A) may be disposed at a corner in the x-axis positive direction and a y-axis negative direction of the orthogonal coordinate system based on the center of the display. The fourth audio output module (e.g., 214 of FIG. 2A) may be disposed at a corner in the x-axis negative direction and the y-axis negative direction of the orthogonal coordinate system based on the center of the display.

According to an embodiment, (A) of FIG. 2A is a perspective view of the electronic device 101 with the display unfolded. According to an embodiment, in the case of (A) of FIG. 2A, the audio output modules (e.g., 211, 21, 213, and 214 of FIG. 2A) of the electronic device 101 may output an audio signal.

According to an embodiment, (B) of FIG. 2A is a perspective view of the electronic device 101 with the display folded with respect to the folding axis 201. In the case of (B) of FIG. 2A, there may be interference occurring between audio output modules 211 and 212 or between audio output modules 213 and 214.

FIG. 2B is a view of the electronic device 101 in the flex state of the display when the display of the electronic device 101 is a foldable display according to various embodiments.

FIG. 2B illustrates examples of how an audio signal is output from each of audio output modules (e.g., 211 and 212 of FIG. 2B) (e.g., 211 and 212 of FIG. 2A) according to various embodiments.

According to an embodiment, (A) of FIG. 2B illustrates how an audio signal is output from the audio output modules (e.g., 211 and 212 of FIG. 2B) when the flex state of the display is a first state. According to an embodiment, the first state may refer, for example, to a state in which the display is unfolded.

According to an embodiment, (B) of FIG. 2B illustrates how an audio signal is output from the audio output modules (e.g., 211 and 212 of FIG. 2B) when the flex state of the display is a second state. According to an embodiment, the second state may refer, for example, to a state in which a portion of the display is bent.

According to an embodiment, (C) of FIG. 2B illustrates how an audio signal is output from the audio output modules (e.g., 211 and 212 of FIG. 2B) when the flex state of the display is in a third state.

According to an embodiment, as a distance between the audio output modules (e.g., 211 and 212 of FIG. 2B) decreases, interference between audio signals output by the audio output modules may increase, and a sound effect may be reduced.

According to an embodiment, audio signal interference generated in the case of (B) of FIG. 2B may be greater than audio signal interference generated in the case of (C) of FIG. 2B, and the audio signal interference generated in the case of (C) of FIG. 2B may be greater than audio signal interference generated in the case of (A) of FIG. 2B.

FIG. 2C is a perspective view of the electronic device 101 in the flex state of the display when the display of the electronic device 101 is a rollable display according to various embodiments.

According to an embodiment, the electronic device 101 may employ a rollable display in which one or more corners are to be rolled or unfolded. According to an embodiment, the electronic device 101 of FIG. 2C may include first through fourth audio output modules (e.g., 211, 212, 213, and 214 of FIG. 2C, e.g., the audio output module 155 of FIG. 1).

The audio output modules (e.g., 211, 212, 213, and 214 of FIG. 2C) of FIG. 2C are provided only as an example, and the number and positioning of audio output modules included in the electronic device 101 is not limited thereto.

The first audio output module (e.g., 211 of FIG. 2C) may be disposed at a corner in an x-axis positive direction and a y-axis positive direction of an orthogonal coordinate system based on a center of the display. The second audio output module (e.g., 212 of FIG. 2C) may be disposed at a corner in an x-axis negative direction and the y-axis positive direction of the orthogonal coordinate system based on the center of the display.

The third audio output module (e.g., 213 of FIG. 2C) may be disposed at a corner in the x-axis positive direction and a y-axis negative direction of the orthogonal coordinate system based on the center of the display. The fourth audio output module (e.g., 214 of FIG. 2C) may be disposed at a corner in the x-axis negative direction and the y-axis negative direction of the orthogonal coordinate system based on the center of the display.

According to an embodiment, (A) of FIG. 2C is a perspective view of the electronic device 101 in which one corner of the display is rolled according to an embodiment. According to an embodiment, in the case of (A) of FIG. 2C, audio output modules (e.g., 212 and 214 of FIG. 2C) of the electronic device 101 may be received inward the electronic device 101. According to an embodiment, when an audio signal is output in the case of (A) of FIG. 2C, there may be interference between audio signals output from the audio output modules (e.g., 212 and 214 of FIG. 2C) of the electronic device 101.

According to an embodiment, (B) of FIG. 2C is a perspective view of the electronic device 101 with all corners of the display unfolded according to an embodiment. According to an embodiment, in the case of (B) of FIG. 2C, audio output modules (e.g., 211, 212, 213, and 214 of FIG. 2C) may output an audio signal.

FIG. 2D is a perspective view of the electronic device 101 configured to output an audio signal based on the flex state of the display when the display of the electronic device 101 is a rollable display according to various embodiments.

FIG. 2D is a perspective view of the electronic device 101 in which an audio signal is output from all audio output modules (e.g., 211, 212, 213, and 214 of FIG. 2D) (e.g., 211, 212, 213, and 214 of FIG. 2C) of the electronic device 101 according to an embodiment.

According to an embodiment, (A) of FIG. 2D is a perspective view of the electronic device 101 in which all corners of the display are unfolded according to an embodiment. According to an embodiment, (B) of FIG. 2D is a perspective view of the electronic device 101 in which one corner of the display is rolled up according to an embodiment.

According to an embodiment, in the case of (B) of FIG. 2D, the audio output modules (e.g., 212 and 214 of FIG. 2C) are received inward the electronic device 101, and thus there may be interference inside the electronic device 101 when an audio signal is output from the audio output modules.

FIG. 3 is a diagram illustrating an example audio output module used based on a flex state of a display of an example electronic device according to various embodiments.

According to an embodiment, to reduce audio signal interference, audio output modules (e.g., 211, 212, 213, and 214 of FIG. 3) (e.g., the audio output module 155 of FIG. 1, and 211, 212, 213, and 214 of FIGS. 2A and 2C) may be set differently.

According to an embodiment, referring to (A) of FIG. 3, some audio output modules (e.g., 212 and 214 of FIG. 3) may be set not to output an audio signal, to reduce audio signal interference that may occur when the display of the electronic device 101 is a foldable display and a flex state of the display is a second state.

According to an embodiment, in the case of (A) of FIG. 3, when the flex state of the display is the second state, the audio signal interference may not occur between audio output modules (e.g., 211 and 212 of (A) of FIG. 3, or 213 and 214 of (A) of FIG. 3).

According to an embodiment, in the case of (A) of FIG. 3, when the display of the electronic device 101 is a foldable display and the flex state of the display is the second state, some audio output modules (e.g., 211 and 213 of (A) of FIG. 3) among a plurality of audio output modules (e.g., 211, 212, 213, and 214 of (A) of FIG. 3) may output an audio signal.

According to an embodiment, referring to (A) of FIG. 3, the electronic device 101 may determine an audio signal channel to be 2-channel to reduce audio signal interference that may occur when the display of the electronic device 101 is a foldable display and the flex state of the display is the second state.

According to an embodiment, referring to (B) of FIG. 3, when the display of the electronic device 101 is a foldable display and the flex state of the display is a first state, all audio output modules (e.g., 211, 212, 213, and 214 of FIG. 3) may be set to output an audio signal.

According to an embodiment, referring to (B) of FIG. 3, when the display of the electronic device 101 is a foldable display and the flex state of the display is the first state, the electronic device 101 may set an audio signal channel to be 4-channel.

According to an embodiment, referring to (C) of FIG. 3, some audio output modules (e.g., 212 and 214 of (C) of FIG. 3) may be set not to output an audio signal when the display of the electronic device 101 is a rollable display and the flex state of the display is the second state.

According to an embodiment, referring to (C) of FIG. 3, when the flex state of the display is the second state, the audio output modules (e.g., 212 and 214 of (C) of FIG. 3) do not output an audio signal, and thus audio signal interference may not occur inside the electronic device 101.

According to an embodiment, referring to (C) of FIG. 3, when the display of the electronic device 101 is a rollable display and the flex state of the display is the second state, some audio output modules (e.g., 211 and 213 of (C) of FIG. 3) among the audio output modules (e.g., 211, 212, 213, and 214 of (C) of FIG. 3) may output an audio signal.

According to an embodiment, referring to (C) of FIG. 3, the electronic device 101 may determine an audio signal channel to be 2-channel to reduce audio signal interference that may occur when the display of the electronic device 101 is a rollable display and the flex state of the display is the second state.

According to an embodiment, referring to (D) of FIG. 3, when the display of the electronic device 101 is a rollable display and the flex state of the display is the first state, all audio output modules (e.g., 211, 212, 213, and 214 of (D) of FIG. 3) may be set to output an audio signal.

According to an embodiment, referring to (D) of FIG. 3, when the display of the electronic device 101 is a rollable display and the flex state of the display is the first state, the electronic device 101 may determine an audio signal channel to be 4-channel.

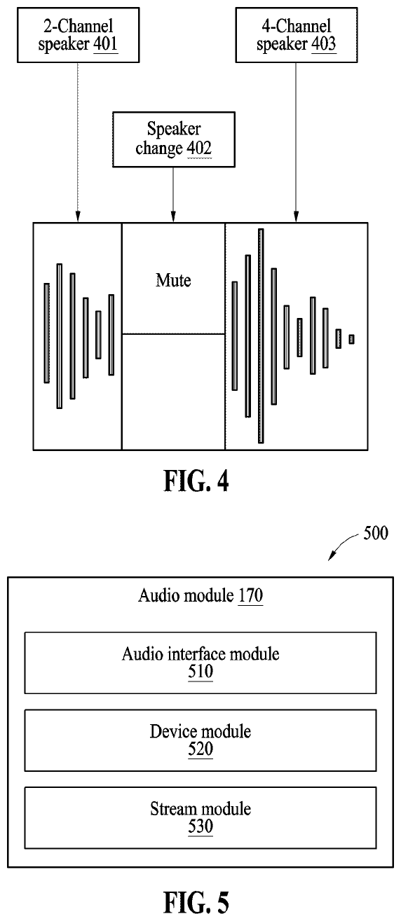

FIG. 4 is a diagram illustrating an example of an occurrence of a mute interval in a process of outputting an audio signal as a flex state of a display of an example electronic device is changed according to various embodiments.

When an audio signal channel is changed as shown in FIG. 3, a mute interval 402 may occur due to audio signal rerouting. When the number of audio output modules (e.g., the audio output module 155 of FIG. 1) that output an audio signal is changed as shown in FIG. 3, the mute interval 402 may occur due to rerouting of the audio signal.

As shown in FIG. 4, for an audio signal interval 401 in which an audio signal is output through 2-channel, audio signal routing may not be set for some of audio output modules of the electronic device 101. As shown in FIG. 4, for an audio signal interval 403 in which an audio signal is output through 4-channel, routing may be set for four audio output modules of the electronic device 101.

As shown in FIG. 4, the mute interval 402 may occur as the shape of the display is changed and the number of audio output modules to be used to output an audio signal is changed accordingly, and thus audio signal routing is reset.

According to various embodiments, to prevent occurrence of the mute interval 402, the processor 120 of the electronic device 101 may set audio signal routing for all the audio output modules included in the electronic device 101, when a request for outputting an audio signal occurs in a program (e.g., the program 140 of FIG. 1) of the electronic device 101.

According to various embodiments, to prevent occurrence of the mute interval 402, the processor 120 of the electronic device 101 may set all the audio output modules included in the electronic device 101 to be in an output-available state, when a request for outputting an audio signal occurs in the program of the electronic device 101.

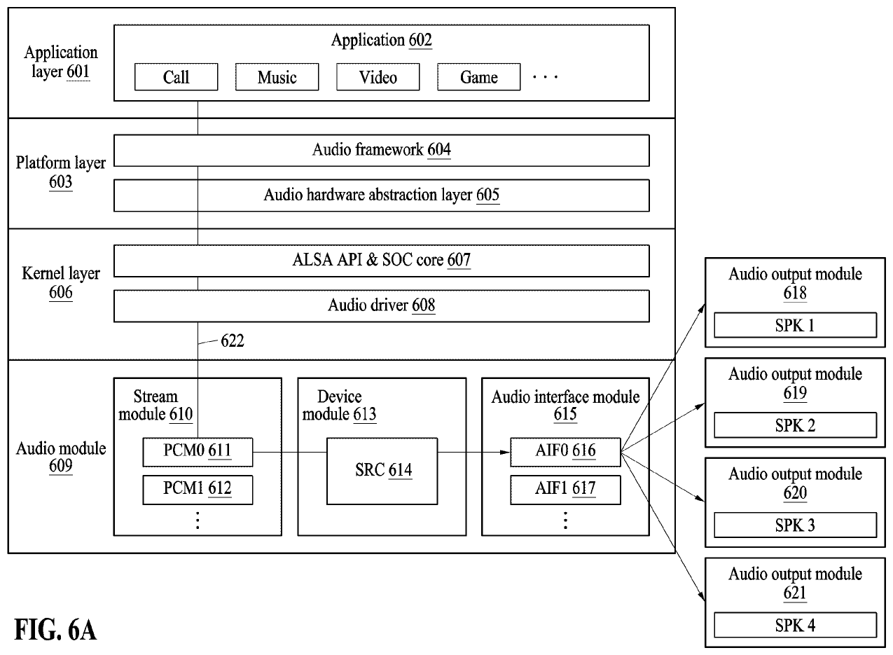

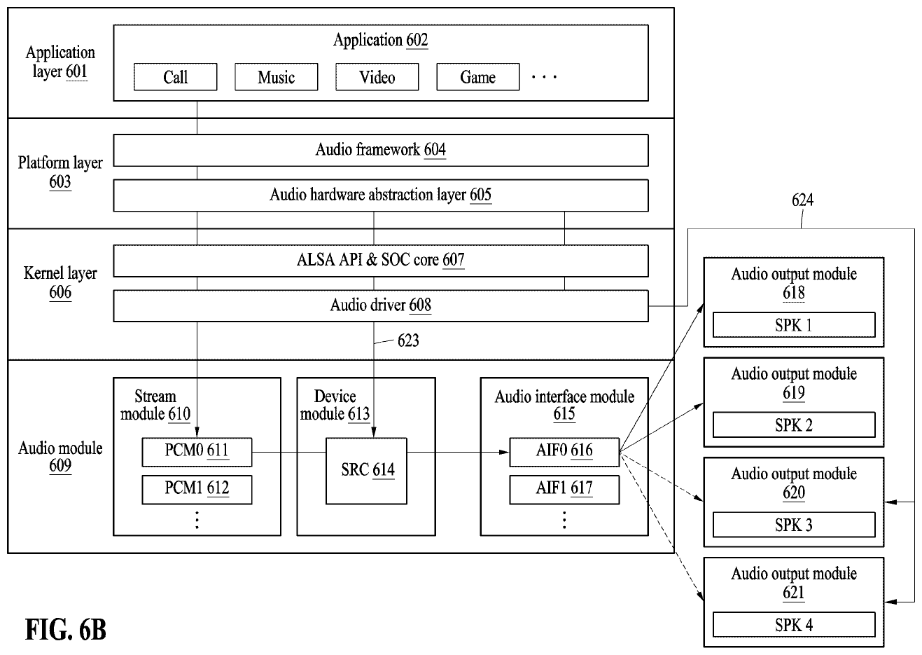

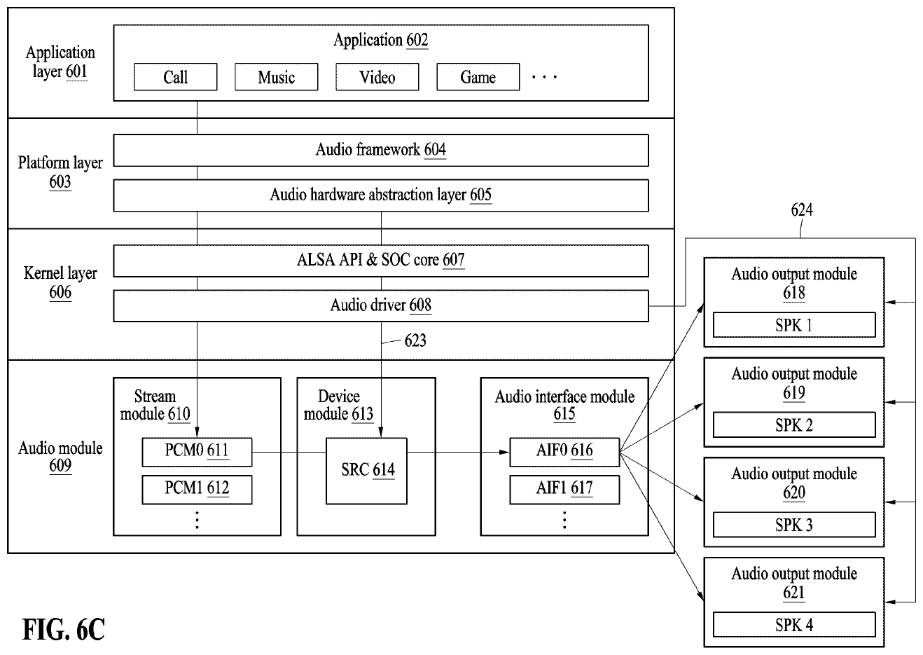

According to various embodiments, the processor 120 of the electronic device 101 may determine an audio signal channel based on a flex state of the display and determine an audio output module for outputting an audio signal from among a plurality of audio output modules according to the determined channel. According to various embodiments, the processor 120 of the electronic device 101 may deactivate an audio output module that is not determined as the audio output module for outputting an audio signal from among the plurality of audio output modules. The deactivation of an audio output module will be described in detail below with reference to FIGS. 6A, 6B, and 6C.

According to various embodiments, when the flex state of the display is changed, the processor 120 of the electronic device 101 may change the audio signal channel according to the changed flex state, and output the audio signal by activating a deactivated audio output module or deactivate an audio output module outputting the audio signal based on the changed channel, thereby changing the audio signal channel and outputting the audio signal without the mute interval 402 even when the flex state of the display is changed.

FIG. 5 is a block diagram 500 illustrating an example audio module 170 according to various embodiments. Referring to FIG. 5, the audio module 170 may include an audio interface module 510, a device module 520, and a stream module 530. The operations of the audio module 170 may be controlled by an auxiliary processor (e.g., the auxiliary processor 123). For example, the auxiliary processor controlling the operations of the audio module 170 of FIG. 5 may be a digital signal processor (DSP).

The audio interface module 510 may receive an audio signal corresponding to a sound obtained from the outside of the electronic device 101 via a microphone (e.g., a dynamic microphone, a condenser microphone, or a piezo microphone) that is configured as a part of the input module 150 or separately from the electronic device 101. For example, when the audio signal is obtained from the external electronic device 102 (e.g., a headset or a microphone), the audio interface module 510 may be connected to the external electronic device 102 directly via the connecting terminal 178, or wirelessly (e.g., Bluetooth™ communication) via the wireless communication module 192 to receive the audio signal. According to an embodiment, the audio interface module 510 may receive a control signal (e.g., a volume adjustment signal received through an input button) associated with the audio signal obtained from the external electronic device 102. The audio interface module 510 may include, for example, a plurality of audio input channels, and each of the audio input channels may receive an audio signal different for each audio input channel. According to an embodiment, additionally or alternatively, the audio interface module 510 may receive an audio signal from another component (e.g., the processor 120 or the memory 130) of the electronic device 101.

The device module 520 may include, for example, an audio input mixer, an analog-to-digital converter (ADC), a digital-to-analog converter (DAC), an audio output mixer, and a sample rate converter (SRC).

The stream module 530 may include, for example, an audio signal processor and a buffer module. According to an embodiment, the buffer module may be a pulse-code modulation (PCM) buffer. The buffer module may store, in a buffer, a digitized audio signal (e.g., a PCM signal) received from the main processor 121. The audio signal stored in the buffer module may be transferred to the device module 520 by the auxiliary processor 123 and be converted to an analog signal.

The audio input mixer may mix a plurality of input audio signals into at least one audio signal. For example, according to an embodiment, the audio input mixer may mix a plurality of analog audio signals input through the audio interface module 510 into at least one analog audio signal.

The ADC may convert an analog audio signal to a digital audio signal. For example, according to an embodiment, the ADC may convert, to a digital audio signal, an analog audio signal received through the audio interface module 510 or, additionally or alternatively, convert an analog audio signal mixed through the audio input mixer.

The DAC may convert a digital audio signal to an analog audio signal. For example, according to an embodiment, the DAC may convert, to an analog audio signal, a digital audio signal processed by the audio signal processor or a digital audio signal obtained from another component (e.g., the processor 120 or the memory 130) of the electronic device 101.

The audio output mixer may mix a plurality of audio signals, which are to be output, into at least one audio signal. For example, according to an embodiment, the audio output mixer may mix an analog audio signal converted by the DAC and another analog audio signal (e.g., an analog audio signal received through the audio interface module 510) into at least one analog audio signal.

The SRC may perform audio signal sampling and convert a channel of an audio signal received from the stream module 530 to a channel determined by the main processor 121. For example, the SRC may convert a 2-channel audio signal to a 4-channel audio signal, and may convert a 4-channel audio signal to a 2-channel audio signal.

The audio interface module 510 may output, to the outside of the electronic device 101 through the audio output module 155, the analog audio signal obtained through the conversion by the DAC or, additionally or alternatively, output the analog audio signal mixed by the audio output mixer. The audio output module 155 may include, for example, a speaker, such as a dynamic driver or a balanced armature driver, or a receiver. According to an embodiment, an electronic device may include a plurality of audio output modules 155. In this case, the audio interface module 510 may output audio signals having a plurality of different channels (e.g., stereo or 5.1 channels) through at least some of the audio output modules 155. According to an embodiment, the audio interface module 510 may be connected to the external electronic device 102 (e.g., an external speaker or a headset) directly via the connecting terminal 178 or wirelessly via the wireless communication module 192 to output an audio signal.

According to an embodiment, the audio module 170 may generate at least one digital audio signal by mixing a plurality of digital audio signals using at least one function of the audio signal processor, without separately having the audio input mixer or the audio output mixer.

The audio signal processor may process, in various ways, a digital audio signal received through the ADC or a digital audio signal received from another component of the electronic device 101. For example, according to an embodiment, the audio signal processor may perform, on at least one digital audio signal, changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal. According to an embodiment, the at least one function of the audio signal processor may be implemented in the form of an equalizer.

According to an embodiment, the audio module 170 may include an audio amplifier (not shown) (e.g., a speaker amplifying circuit) configured to amplify an analog audio signal input through the audio interface module 510 or an audio signal that is to be output through the audio interface module 510. According to an embodiment, the audio amplifier may be configured as a module separate from the audio module 170.

FIGS. 6A, 6B, and 6C are diagrams illustrating a system layer of an example electronic device for outputting an audio signal according to various embodiments.

A request to output an audio signal may occur in an application layer 601 (e.g., application 146 of FIG. 1), a platform layer 603 (e.g., the middleware 144 of FIG. 1), or a kernel layer 606 (e.g., the OS 142 of FIG. 1).

An audio framework 604 may provide an application programming interface (API) for generating an audio signal according to an application 602. An audio hardware abstraction layer 605 may transfer, to the kernel layer 606, control or information about the type, path, and volume level of the audio signal suitable for an environment requested by the application 602.

An advanced Linux sound architecture (ALSA) API (ALSA API) & system on chip (SOC) 607, which is a part of ALSA used to drive or control audio signals in the electronic device 101, may transfer a command of the platform layer 603 to the kernel layer 606.

An audio driver 608 may control the audio module 170, such as a microphone in an input module, or control an amplifier (AMP) or a receiver of speakers included in audio output modules 618, 619, 620, and 621 (e.g., the audio output module 155 of FIG. 1). An audio module 609 (e.g., the audio module 170 of FIG. 1) may convert a digitized audio signal to an analog signal and transmit it to the audio output modules 618, 619, 620, and 621.

PCM0 611 and PCM1 612 may be PCM buffers for processing audio signals requested by different applications, respectively. AIF0 616 and AIF1 617 may be audio interfaces for processing audio signals requested by different applications, respectively. The audio output modules 618, 619, 620, and 621 may include different speakers SPK1 to SPK4, respectively.

According to an embodiment, referring to FIGS. 6A, 6B, and 6C, by the request for the audio signal from the application 602 (e.g., the application 146 of FIG. 1) such as, for example, a call or music, the audio signal may be generated, and the audio signal may be written on a buffer module (e.g., 611) through the platform layer 603 and the kernel layer 606 and may be output by the audio output modules 618, 619, 620, and 621 through an SRC 614 and the AIF0 616.

According to various embodiments, referring to FIG. 6A, when a request for an audio signal occurs in the application layer 601, routing 622 from the application layer 601 to the audio output modules 618, 619, 620, and 621 of the electronic device 101 may need to be set to output the audio signal.

According to an embodiment, when a request to output an audio signal occurs in the application layer 601, the processor 120 of the electronic device 101 may set the audio output modules 618, 619, 620, and 621 to be in an output-available state by setting the routing 622 for the audio signal regardless of an audio signal channel.

According to an embodiment, FIG. 6B shows a system layer of an example electronic device 101 for outputting an audio signal when an audio signal channel is determined to be 2-channel according to a flex state of a display of the electronic device 101.

According to an embodiment, when the audio signal channel is determined to be 2-channel according to the flex state of the display as shown, for example, in (A) and (C) of FIG. 3, to reduce an audio signal interference that may occur according to a degree of bending of the display, only some (e.g., the audio output modules 618 and 619) of the audio output modules 618, 619, 620, and 621 may be used to output an audio signal.

According to an embodiment, referring to FIG. 6B, the processor 120 may determine an audio signal channel according to the flex state of the display. The audio signal channel according to the flex state may be determined in advance.

For example, the audio signal channel may be determined to be 2-channel when the flex state of the display is a first state (for example, as shown in (A) of FIG. 2A, (A) of FIG. 2B, (B) of FIG. 2C, and (B) and (D) of FIG. 3), and to be 4-channel when the flex state is a second state (for example, as shown in (B) of FIG. 2A, (B) of FIG. 2B, (A) of FIG. 2C, and (A) and (C) of FIG. 3).

According to an embodiment, the audio signal channel may be determined to be 5-channel or 6-channel when the flex state of the display is a third state or a fourth state, respectively. The audio signal channel according to the flex state of the display is not limited to the foregoing examples and may be predetermined to be various relationships.

According to an embodiment, referring to FIG. 6B, the processor 120 may determine an audio signal channel to be 2-channel according to the flex state of the display, and determine an audio output module (e.g., the audio output modules 618 and 619) for outputting an audio signal from among the plurality of audio output modules 618, 619, 620, and 621 according to the determined audio signal channel. The audio output modules 618, 619, 620, and 621 configured to output audio signals according to an audio signal channel may be set in advance based on positions of the audio output modules 618, 619, 620, and 621, and are not limited to the example described above.

For example, when the audio output modules 618 and 619 are disposed at a position 211 and a position 213 in (A) and (C) of FIG. 3, they may be determined as the audio output modules for outputting an audio signal when the flex state of the display is a second state.

According to an embodiment, among the plurality of audio output modules 618, 619, 620, and 621, the audio output modules 620 and 621 that are not determined as the audio output modules for outputting an audio signal may be deactivated by the processor 120, and the audio output modules 618 and 619 that are determined as the audio output module for outputting an audio signal may be activated by the processor 120.

According to an embodiment, the processor 120 may deactivate the audio output modules 620 and 621 and activate the audio output modules 618 and 619 through the audio driver 608. For example, the processor 120 may generate a control command 624 for controlling the audio output modules 618, 619, 620, and 621 to turn on or off AMP switches of speakers of the audio output modules 618, 619, 620, and 621 through the audio driver 608, and may thereby activate or deactivate the audio output modules 618, 619, 620, and 621. For example, turning on or off the AMP switches of the speakers of the audio output modules 618, 619, 620, and 621 may include turning on or off an audio signal and/or power to be input to the AMP of the speakers of the audio output modules 618, 619, 620, and 621.

According to an embodiment, when the flex state of the display is changed while the audio signal is being output, the processor 120 may generate a control command 624 for controlling the audio output modules 618, 619, 620, and 621, rather than set again the routing 622 for the audio signal, to change the audio signal channel by turning on or off the AMP switches of the speakers of the audio output modules 618, 619, 620, and 621 through the audio driver 608 and output the audio signal without a mute interval.

According to an embodiment, referring to FIG. 6B, when the determined audio signal channel is changed from 4-channel to 2-channel as the flex state of the display is changed from the first state to the second state, the processor 120 may deactivate the audio output modules 620 and 621 that are not used for 2-channel among the activated audio output modules 618, 619, 620, and 621, and may thereby control the audio output modules 618 and 619 to output the audio signal without a mute interval even when the shape of the display is changed.

According to an embodiment, when a 4-channel audio signal is generated by request of the application layer 601 and the audio signal channel is determined to be a 2-channel audio signal according to the flex state of the display, the processor 120 may generate the control command 623 for converting the channel to control the 4-channel audio signal to change to 2-channel in a device module 613, and may deactivate the audio output modules 620 and 621 that are not used for the 2-channel audio signal among the activated audio output modules 618, 619, 620, and 621.

According to an embodiment, when a 2-channel audio signal is generated by request of the application layer 601 and the audio signal channel is determined to be 2-channel according to the flex state of the display, the processor 120 may deactivate the audio output modules 620 and 621 that are not used for the 2-channel audio signal among the activated audio output modules 618, 619, 620, and 621, without the control command 623 for converting the channel.

According to an embodiment, the audio signal routing 622 may be set for all the audio output modules 618, 619, 620, and 621 when the output of an audio signal starts, and thus the audio signal may be transmitted to the audio output modules 618, 619, 620, and 621 regardless of whether the audio output modules 618, 619, 620, and 621 are activated or not.

According to an embodiment, FIG. 6C shows a system layer of an example electronic device 101 for outputting an audio signal when an audio signal channel is determined to be 4-channel according to the flex state of the display.

According to an embodiment, referring to FIG. 6C, when the flex state of the display is changed to or determined as the first state as shown in (B) and (D) of FIG. 3, the audio signal channel may be determined to be 4-channel, and the audio output modules 618, 619, 620, and 621 may be used to output an audio signal.

According to an embodiment, referring to FIG. 6C, the processor 120 may determine the audio signal channel to be 4-channel according to the flex state of the display, and determine an audio output module for outputting an audio signal from among the plurality of audio output modules 618, 619, 620, and 621 according to the determined audio signal channel.

According to an embodiment, when the flex state of the display is changed while the audio signal is being output, the processor 120 may generate the control command 624 for controlling the audio output modules 618, 619, 620, and 621, rather than set again the routing 622 for audio signals, to turn on or off the AMP switches of the speakers of the audio output modules 618, 619, 620, and 621 through the audio driver 608, and may thereby change the audio signal channel and output the audio signal without a mute interval.

According to an embodiment, referring to FIG. 6C, when the determined audio signal channel is changed from 2-channel to 4-channel as the flex state of the display is changed from the second state to the first state, the processor 120 may activate the deactivated audio output modules 620 and 621 and may thereby control the audio output modules 618, 619, 620, and 621 to output the audio signal without a mute interval even when the shape of the display is changed.

According to an embodiment, when a 2-channel audio signal is generated by request of the application layer 601 and the audio signal channel is determined to be 4-channel according to the flex state of the display, the processor 120 may generate the control command 623 for converting the channel to control the 2-channel audio signal to be converted to 4-channel in the device module 613, and activate the deactivated audio output modules 620 and 621 among the activated audio output modules 618, 619, 620, and 621.

According to an embodiment, when a 4-channel audio signal is generated by request of the application layer 601 and the audio signal channel is determined to be 4-channel according to the flex state of the display, the processor 120 may activate the deactivated audio output modules 620 and 621 among the activated audio output modules 618 to 621 without the control command 623 for converting the channel.

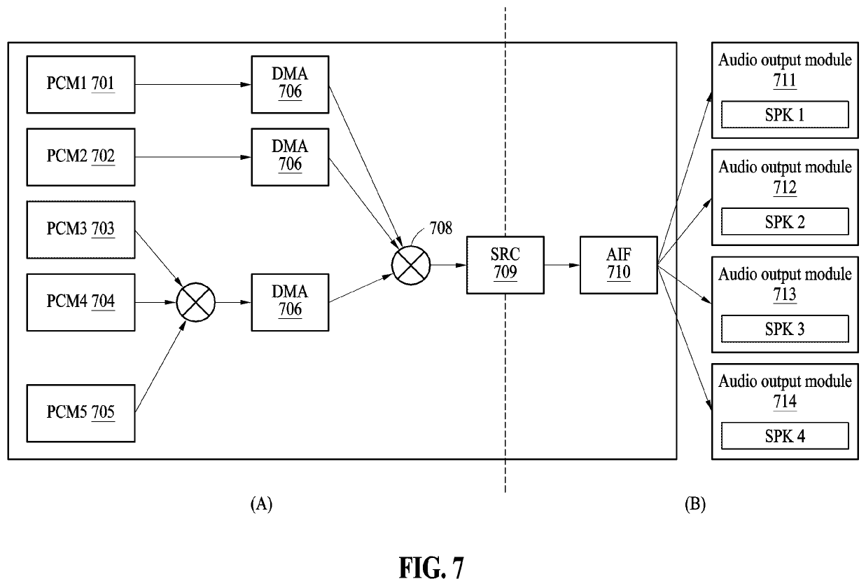

FIG. 7 is a diagram illustrating an example process of processing an audio signal in an audio module according to various embodiments.

PCM1 701, PCM2 702, PCM3 703, PCM4 704, and PCM5 705 (e.g., PCM0 611 and PCM1 612 of FIG. 6) may be buffer modules (e.g., PCM modules) that process different audio signals according to a type of application (e.g., the application 146 of FIG. 1). For example, PCM1 may process an audio signal requested by a music application, PCM2 may process an audio signal requested by a video application, and PCM3 may process an audio signal requested by a game application.

An audio signal received by each buffer module may be transferred to an SRC 709 through a direct memory access (DMA) 706, a software mixer 707, and a hardware mixer 708. In the SRC 709, an audio signal channel conversion may be performed.

For example, when a channel of an audio signal received by the SRC 709 is 4-channel, but a channel determined according to a flex state of a display is 2-channel, the audio signal received by the SRC 709 may be converted from 4-channel to 2-channel by a control command (e.g., the control command 623 of FIG. 6) of the processor 120.

For example, when the channel of the audio signal received by the SRC 709 is 2-channel, but the channel determined according to the flex state of the display is 4-channel, the audio signal received by the SRC 709 may be converted from 2-channel to 4-channel by a control command (e.g., the control command 623 of FIG. 6) of the processor 120.

An AIF 710 (e.g., AIF0 616 of FIG. 6) may transmit the audio signal received from the SRC 709 to audio output modules 711, 712, 713, and 714 (e.g., the audio output modules 155 of FIG. 1). The operations described above with reference to FIG. 7 may be performed by the auxiliary processor 123 according to a control command of the main processor 121.

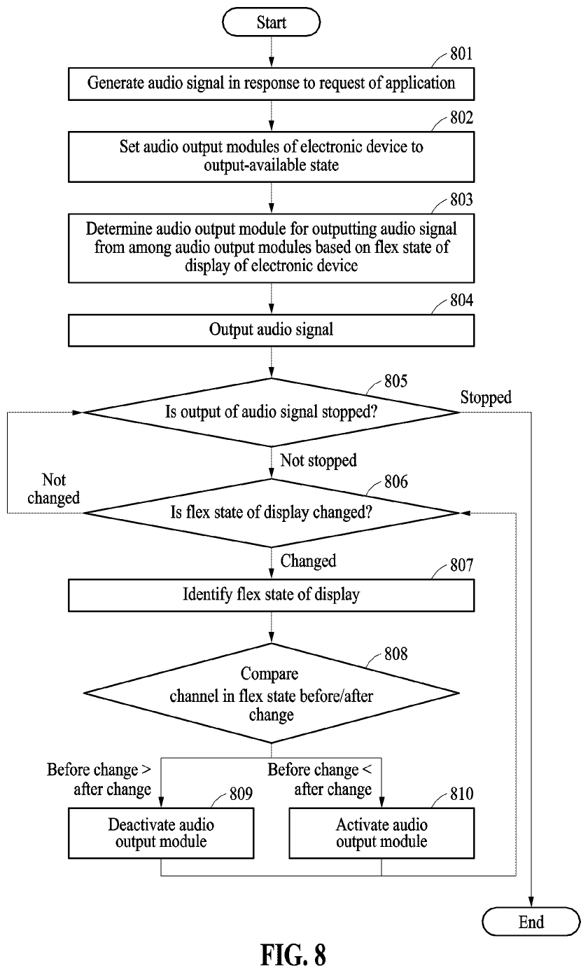

FIG. 8 is a flowchart illustrating an example method of outputting an audio signal according to various embodiments.

Operations to be described hereinafter may be performed in sequential order, but are not necessarily performed in sequential order. For example, the order of the operations may be changed, and/or at least two of the operations may be performed in parallel.

In operation 801, the processor 120 may generate an audio signal by request of an application (e.g., the application 146 of FIG. 1). When a request for the audio signal occurs in the application, the processor 120 may set routing (e.g., the routing 622 of FIG. 6A) for the audio signal from the application to an audio output module (e.g., the audio output module 155 of FIG. 1).

In operation 802, the processor 120 may set a plurality of audio output modules of the electronic device 101 to be in an output-available state. When the request for the audio signal occurs in the application, the processor 120 may set all the audio output modules to be in the output-available state by setting the routing for the audio signal regardless of a channel of the audio signal.

In operation 803, the processor 120 may determine an audio output module for outputting the audio signal from among the plurality of audio output modules based on a flex state of a display of the electronic device 101. The processor 120 may identify the flex state at a time at which the request for the audio signal occurs and may identify the flex state at a time at which the shape of the display is changed.

The processor 120 may determine the channel of the audio signal according to the flex state, and determine the audio output module for outputting the audio signal from among the plurality of audio output modules based on the channel of the audio signal. For each channel of the audio signal, an audio output module for outputting the audio signal may be set in advance.

The processor 120 may activate an audio output module that is determined to output the audio signal through an audio driver and deactivate an audio output module that is determined not to output the audio signal.

In operation 804, the processor 120 may output the audio signal through the audio output module that is determined as the audio output module for outputting the audio signal. In operation 805, the processor 120 may determine whether to stop outputting the audio signal.

When a request for stopping the output of the audio signal is received, the processor 120 may stop outputting the audio signal and cancel the routing set on the plurality of audio output modules.

In operation 806, when the request for stopping the output of the audio signal is not received, the processor 120 may determine whether the flex state of the display is changed. When the flex state of the display has not changed, the processor 120 may continue outputting the audio signal and perform operation 805 again.

In operation 807, when the flex state of the display has changed, the processor 120 may identify the changed flex state. In operation 808, the processor 120 may compare the channel according to the flex state before the change to the channel according to the flex state after the change.

For example, when, during the output of the audio signal, the flex state of the display is changed from a first state to a second state, and the channel of the audio signal is set to be 4-channel in the first state and 2-channel in the second state, the processor 120 may convert the channel of the audio signal and deactivate some audio output modules among audio output modules outputting the audio signal.

For example, when, during the output of the audio signal, the flex state of the display is changed from the second state to the first state, and the channel of the audio signal is set to be 4-channel in the first state and 2-channel in the second state, the processor 120 may convert the channel of the audio signal and deactivate some audio output modules among the audio output modules outputting the audio signal.

In operation 809, when the channel according to the flex state before the change is greater than the channel according to the flex state after the change, the processor 120 may deactivate some audio output modules among the audio output modules outputting the audio signal.

In operation 810, when the channel according to the flex state after the change is greater than the channel according to the flex state before the change, the processor 120 may activate some audio output modules among the deactivated audio output modules. The processor 120 may perform operation 806 after performing operations 809 and 810.

According to an example embodiment, the operations of setting routing for an audio signal, determining a channel of the audio signal according to a flex state, or controlling audio output modules (e.g., the audio output module 155) to be deactivated and activated according to the channel of the audio signal may be performed by the main processor 121.

According to an example embodiment, the operations of inputting the audio signal to a buffer module, converting the channel of the audio signal to a channel determined by the main processor 121 through a device module, and transmitting the audio signal to the audio output module 155 may be performed by the auxiliary processor 123.

According to various example embodiments, an electronic device 101 includes a display module 160 including a display that is bent or unfolded and configured to provide content; a plurality of audio output modules 155 configured to output an audio signal; an audio module 170 configured to convert the audio signal to an analog signal or convert an analog signal to the audio signal; and a processor 120 electrically connected to the display module 160, the plurality of audio output modules 155, and the audio module 170, wherein the processor 120 is configured to set the plurality of audio output modules 155 to be in an output-available state; determine an audio output module 155 for outputting the audio signal from among the plurality of audio output modules 155 based on a flex state of the display; transmit the audio signal converted to the analog signal by the audio module 170 to the plurality of audio output modules 155; and output, by the audio output module 155 determined to output the audio signal from among the plurality of audio output modules 155, the audio signal converted to the analog signal.

The display may provide content as it is folded or unfolded.

The display may provide content as one end thereof is rolled or unfolded.

The processor 120 may deactivate an audio output module 155 that is not determined as the audio output module 155 for outputting the audio signal among the plurality of audio output modules 155.

When the flex state of the display is changed from a second state to a first state, the processor 120 may activate an audio output module 155 that is not determined as the audio output module 155 for outputting the audio signal among the plurality of audio output modules 155, and extend a channel of the audio signal through the audio module 170.

When the flex state of the display is changed from the first state to the second state, the processor 120 may deactivate at least one audio output module 155 that is determined as the audio output module 155 for outputting the audio signal among the plurality of audio output modules 155, and reduce the channel of the audio signal through the audio module 170.

The first state may be a state in which the display is unfolded, and the second state may be a state in which a portion of the display is bent.

According to various example embodiments, an electronic device 101 includes a display module 160 including a display that is bent or unfolded and provides content; a plurality of audio output modules 155 configured to output an audio signal; an auxiliary processor 123 configured to process the audio signal; and a main processor 121 electrically connected to the display module 160, the plurality of audio output modules 155, and the auxiliary processor 123, wherein the main processor 121 is configured to set routing for the audio signal through the auxiliary processor 123 such that the audio signal is transmitted to the plurality of audio output modules 155; determine a channel of the audio signal based on a flex state of the display; and set whether to activate each of the plurality of audio output modules 155 according to the determined channel, and wherein the auxiliary processor 123 is configured to receive the audio signal from the main processor 121; and transmit the audio signal to the plurality of audio output modules 155 based on the determined channel. An audio output module 155 activated by the main processor 121 among the plurality of audio output modules 155 is configured to output the audio signal received from the auxiliary processor 123.

When a channel determined by the main processor 121 and a channel of the audio signal received from the main processor 121 are different from each other, the auxiliary processor 123 may convert the channel of the received signal according to the channel determined by the main processor 121.

The display may provide content as one end of the display is rolled or unfolded.

The main processor 121 may deactivate an audio output module 155 that is not determined as the audio output module 155 for outputting the audio signal among the plurality of audio output modules 155.

When the flex state of the display is changed from a second state to a first state, the main processor 121 may activate an audio output module 155 that is not determined as the audio output module 155 for outputting the audio signal among the plurality of audio output modules 155, and extend the channel of the audio signal through the audio module 170.

When the flex state of the display is changed from the first state to the second state, the main processor 121 may deactivate at least one audio output module 155 that is determined as the audio output module 155 for outputting the audio signal among the plurality of audio output modules 155, and reduce the channel of the audio signal through the audio module 170.

According to various example embodiments, a method of outputting an audio signal performed by an electronic device 101 includes setting a plurality of audio output modules 155 of the electronic device 101 to be in an output-available state; determining an audio output module 155 for outputting the audio signal from among the plurality of audio output modules 155 based on a flex state of a display of the electronic device 101; transmitting the audio signal to the plurality of audio output modules 155; and outputting the audio signal by an audio output module 155 determined as the audio output module 155 for outputting the audio signal among the plurality of audio output modules 155.

According to an example embodiment, an electronic device may be a device of one of various types. The electronic device may include, as non-limiting examples, a portable communication device (e.g., a smartphone, etc.), a computing device, a portable multimedia device, a portable medical device, a camera, a wearable device, a home appliance, or the like. However, the electronic device is not limited to the foregoing examples.

It is to be understood that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. Terms such as “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., by wire), wirelessly, or via a third element.

As used in connection with certain embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method described herein may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a display module comprising a display configured to be bent or unfolded and provide content;
a plurality of audio output modules configured to output an audio signal;
an audio module configured to convert the audio signal to an analog signal or convert an analog signal to the audio signal; and
a processor electrically connected to the display module, the plurality of audio output modules, and the audio module,
wherein the processor is configured to:
set the plurality of audio output modules to be in an output-available state;
determine an audio output module for outputting the audio signal from among the plurality of audio output modules based on a flex state of the display; and
transmit the audio signal converted to an analog signal by the audio module to the plurality of audio output modules,
wherein an audio output module determined as the audio output module for outputting the audio signal from among the plurality of audio output modules is configured to output the audio signal converted to the analog signal.

2. The electronic device of claim 1, wherein the display is configured to provide content as it is folded or unfolded around a folding axis.

3. The electronic device of claim 1, wherein the display is configured to provide content as one end thereof is rolled or unfolded.

4. The electronic device of claim 1, wherein the processor is configured to:
deactivate an audio output module that is not determined as the audio output module for outputting the audio signal among the plurality of audio output modules.

5. The electronic device of claim 1, wherein the processor is configured to:
when the flex state of the display changes from a second state to a first state, activate an audio output module that is not determined as the audio output module for outputting the audio signal among the plurality of audio output modules, and extend a channel of the audio signal through the audio module.

6. The electronic device of claim 1, wherein the processor is configured to:
when the flex state of the display changes from a second state to a first state, deactivate at least one audio output module among audio output modules determined as the audio output module for outputting the audio signal among the plurality of audio output modules, and reduce a channel of the audio signal through the audio module.

7. The electronic device of claim 5, wherein the first state is a state in which the display is unfolded, and the second state is a state in which a portion of the display is bent.

8. The electronic device of claim 6, wherein the second state is a state in which the display is unfolded, and the first state is a state in which a portion of the display is bent.

9. An audio signal outputting method performed by an electronic device, the method comprising:
setting a plurality of audio output modules of the electronic device to be in an output-available state;
determining an audio output module for outputting an audio signal from among the plurality of audio output modules based on a flex state of a display of the electronic device;
transmitting the audio signal to the plurality of audio output modules; and
outputting the audio signal to an audio output module determined as the audio output module for outputting the audio signal among the plurality of audio output modules.
